(19) United States
(12) Patent Application Publication
(10) Pub. No.: US 2008/0213076 A1
(43) Pub. Date: Sep. 4, 2008

(54) Edge grip end effector

(76) Inventors: Stephen Hanson, Garland, TX (US); Ulrich Gienger, Fairview, TX (US); Motaz Qutub, Allen, TX (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/072,809

(22) Filed: Feb. 28, 2008

Related U.S. Application Data
(60) Provisional application No. 60/904,610, filed on Mar. 2, 2007.

(51) Int. Cl. B66C 23/00

(52) U.S. Cl. 414/744.1

(57) ABSTRACT

The present invention is directed to an end effector having at least three substrate support members and at least three movable substrate gripping members. In one embodiment, an end effector has at least four substrate support members and at least three movable substrate gripping members. In another embodiment, an end effector has at least four movable substrate support members and at least three movable substrate gripping members.

### PRIORITY

The present non-provisional patent Application claims priority from U.S. Provisional Patent Application having Ser. No. 60/904,610, filed on Mar. 2, 2007, by Hanson et al. and titled EDGE GRIP END EFFECTOR, wherein the entirety of said provisional patent application is incorporated herein by reference.

### FIELD OF THE INVENTION

The present invention is directed to end effectors.

### SUMMARY OF THE INVENTION

An end effector according to the present invention actively grips a substrate such as a wafer by the wafer edges to minimize particle transfer/contamination. One gripping strategy of an end effector according to the present invention can actively grip wafers by their edges with movable substrate gripping members and unmovable substrate support members. Another gripping strategy of an end effector according to the present invention can actively grip wafers by their edges with movable substrate gripping members having separate clean and dirty wafer contact surfaces and movable substrate support members having separate clean and dirty wafer contact surfaces.

An end effector according to the present invention can optionally include non-contact sensors for detecting the presence of a substrate supported on the support members, the position of the support members, and the position of the gripping members.

An end effector according to the present invention can include one or more of the following advantages: minimal particle generation/transfer during wafer handling (the wafer preferably does not slide on landing pads when being transferred); the contact areas are preferably along the edges and can comply with a 1 mm edge exclusion zone; the end effector can be capable of handling notched wafers regardless of notch position relative to end effector; spring biased grips can provide passive, fail safe gripping of wafers; the wafer grip sensor and wafer presence sensor can provide robust wafer gripping indications; sensing implementation allows for diagnostic capabilities; serial communication capability to reduce conductor count going through multi-axis robots; prevent cross contamination between two items being handled; can contact areas at different locations on the perimeter of the item being handled (i.e. to handle notched wafers); can eliminate the need for two separate robots and end effectors where space, cost, reliability and extra teaching time/difficulties are of concern; can accommodate variances in substrate size (i.e., thickness or diameter) and/or substrate shape; can have grippers constructed different materials for chemical or temperature compatibility or the like; can grip an item being handled at different heights on the end effector; and separate wafer contact surfaces for clean and dirty wafers can minimize particle transfer and cross contamination between clean and dirty wafers.

According to one aspect of the present invention, an end effector includes an end effector body portion having a proximal end and a distal end, at least three substrate support members (also called landing pads), and at least three substrate gripping members. Each substrate support member is coupled to the end effector body portion in a manner such that the substrate support members can support a substrate. Each substrate gripping member is movably coupled to the end effector body portion in a manner such that the substrate gripping members can grip and release a wafer supported on the substrate support members.

According to another aspect of the present invention, an end effector includes an end effector body portion having a proximal end and a distal end, at least four substrate support members (also called landing pads), and at least three substrate gripping members. Each substrate support member is unmovably coupled to the end effector body portion in a manner such that the substrate support members can support a substrate. Each substrate gripping member is movably coupled to the end effector body portion in a manner such that the substrate, grip ping members can move linearly within the main plane of the end effector and along an axis (e.g., centerline axis of the end effector body portion, an axis along a chord of a wafer supported upon the substrate support members, and combinations of thereof) so as to grip and release a wafer supported on the substrate support members.

According to another aspect of the present invention, an end effector includes an end effector body portion having a proximal end and a distal end, at least four substrate support members (also called landing pads), and at least three substrate gripping members. Each substrate support member has at least a first and a second wafer contact area. Each substrate support member is movably coupled to the end effector body portion in a manner such that each substrate support member can rotate about an axis (e.g., an axis that is substantially perpendicular to the main plane of the end effector body portion) and such that either all of the first wafer contact areas or all of the second wafer contact areas of the substrate support members are positioned so as to support a substrate. Each substrate gripping member has at least a first and a second wafer contact area. Each substrate gripping member is movably coupled to the end effector body portion in a manner such that each substrate gripping member can rotate about an axis (e.g., an axis that is substantially perpendicular to the main plane of the end effector body portion) and such that either all of the first wafer contact areas or all of the second wafer contact areas of the gripping members are positioned so as to grip and release a wafer supported on the substrate support members.

### BRIEF DESCRIPTION OF THE DRAWINGS

FIG. 1A shows a perspective view of the top of one embodiment of an end effector according to the present invention.

FIG. 1B shows an enlarged partial perspective view of the end effector in FIG. 1A.

FIG. 1C shows a partial perspective view of the end effector in FIG. 1A with cover 199 removed.

FIG. 2A shows a perspective view of the top of a second embodiment of an end effector according to the present invention.

FIG. 2B shows a perspective view of the end effector in FIG. 2A with cover 299 removed.

FIG. 2C shows a perspective view of the bottom of the end effector in FIG. 2A with covers 298 and 299 removed. (Note: upper set of distal drive linkages for gripper set 230 and landing pad set 250 are not shown).

FIG. 3 shows an enlarged partial top view of the end effector in FIG. 2A.

FIG. 4 shows an enlarged partial bottom view of the end effector in FIG. 2A.

FIG. 5 shows an enlarged partial top view of the end effector in FIG. 2A with covers 298 and 299 removed.

FIG. 6 shows an enlarged partial bottom view of the end effector in FIG. 2A with covers 298 and 299 removed.

### DETAILED DESCRIPTION

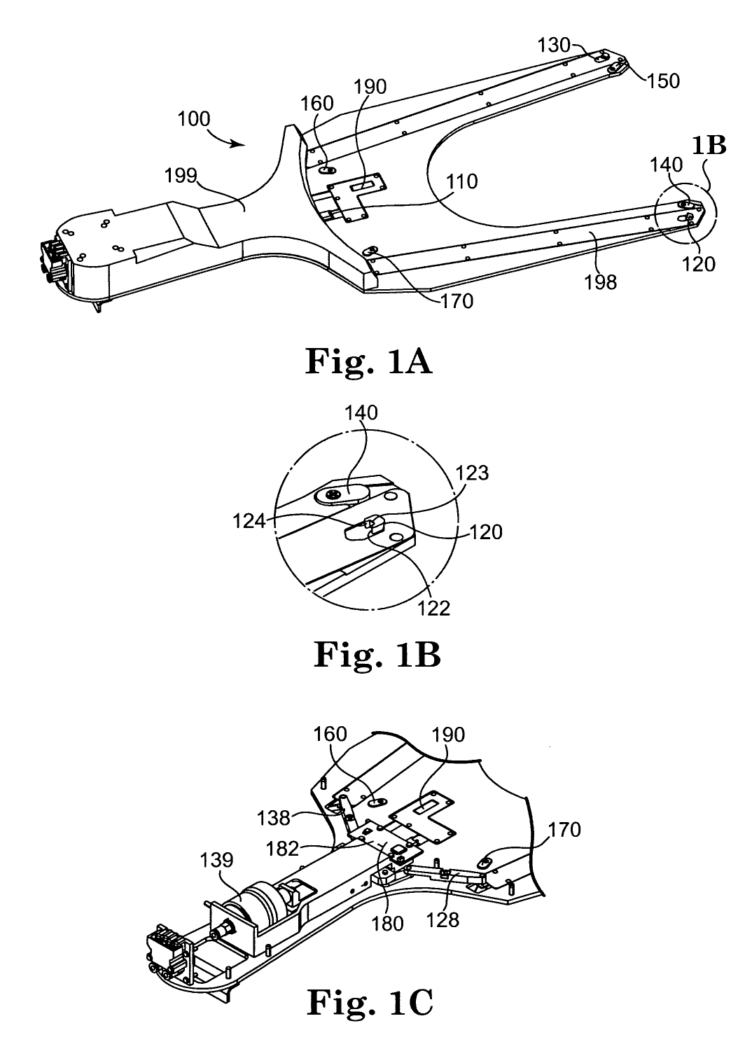

One preferred embodiment of the present invention is shown as end effector 100 in FIGS. 1A-1C and is described below.

End effector 100 includes three active substrate gripping members 110, 120, and 130 around the perimeter of a wafer (not shown). As shown, gripping member 110 is a single proximal gripper and gripping members 120 and 130 are two distal grippers. Preferably, each of the three grippers 110, 120, and 130 have two contact points that allows for handling a notched wafer regardless of the notch position relative to the end effector 100. As shown, distal gripping member 120 includes a recess 123 that forms two contact points 122 and 124. As shown, the grip contact points 122 and 124 of distal gripping member 120 can contact the edges of a wafer and would comply with a 1 mm edge exclusion zone.

As shown, four substrate support members (landing pads) 140, 150, 160, and 170, are provided on which a wafer rests during wafer transfer operations.

The end effector 100 can utilize angled contact surface for substrate support members (also called landing pads) and substrate gripping members to minimize contact area with the wafer and reduce particle generation/transfer. This preferred gripping approach can help minimize wafer movement on the landing pads 140, 150, 160, and 170, during gripping operations and thereby help reduce particle generation.

End effector 100 can optionally include a Hall Effect sensor 180. Hall effect sensor 180 can be utilized to measure the position of the grippers 110, 120, and 130. In one embodiment, Hall effect sensor 180 can provide an analog signal that is fed into a microcontroller 182 to monitor the grip position of the proximal gripper 110 and by inference, the distal grippers 120 and 130. Selectable position tolerance ranges for open, gripped and over-gripped (no wafer) allow for robust operation. Such control architecture can preferably enable implementation of diagnostic capabilities to the end effector 100 with an appropriate code update. Some of the many possible examples for built in diagnostics include one or more of the following: 1) If the actuation time varies this could indicate facilities vacuum variations or wear/leakage in the actuator 139; 2) If the actuation profile changes (jerky or intermittent) this could point to problems with binding in the mechanisms or broken spring; 3) If the nominal wafer grip position varies over time this could be a sign of wear on the gripper contact surfaces (e.g., 122 and 124) or in the actuating mechanisms.

End effector 100 can optionally included a capacitive sensor 190. To enhance reliability, a capacitive sensor 190 can be utilized to detect the presence of a wafer (not shown).

Monitoring of both the grip position sensor 180 and wafer presence sensor 190 with the microcontroller 182 can permit a more robust system with error recovery capability. The microcontroller 182 can provide discrete I/O bits or use serial communication (initial design includes RS-232) to receive commands from or provide status to a wafer handling controller (not shown).

The motion of the three gripping members 110, 120, and 130 is preferably coordinated by 1:1 linkages, including drive linkages 128 and 138, driven from a single actuator 139. The grip points are opposing so the proximal gripper 110 applies the same force as the sum of the two distal grippers 120 and 130. Low friction actuator 139, activated by applying vacuum, opens the grippers 110, 120, and 130 to allow wafers to be removed. Mechanical stops (not shown) are incorporated to limit the maximum open and closed positions. The maximum open grip size range is larger than a wafer to allow for positional errors in wafer transfer (i.e. wafer diameter variations, robot teach errors, wafer drift on chuck or in FOUP, system repeatability, manufacturing tolerances, etc.). Similarly, the minimum closed grip size range allows for undersized wafers. The grippers 110, 120, and 130, are spring (not shown) biased to provide a failsafe means of capturing the wafer in the event of power/facilities loss.

As shown, moving components are enclosed by covers 197, 198, and 199, and purge vacuum is applied to help contain and evacuate any particles generated during operation.

Materials of construction for end effector 100 preferably include aluminum for structural elements and polyetheretherketone (PEEK) for wafer contact areas, although other materials could be utilized (e.g., composite laminates to decrease deflections, stainless steel to decrease cost, ceramic for high stiffness and high temperature resistance, combinations of these, and the like).

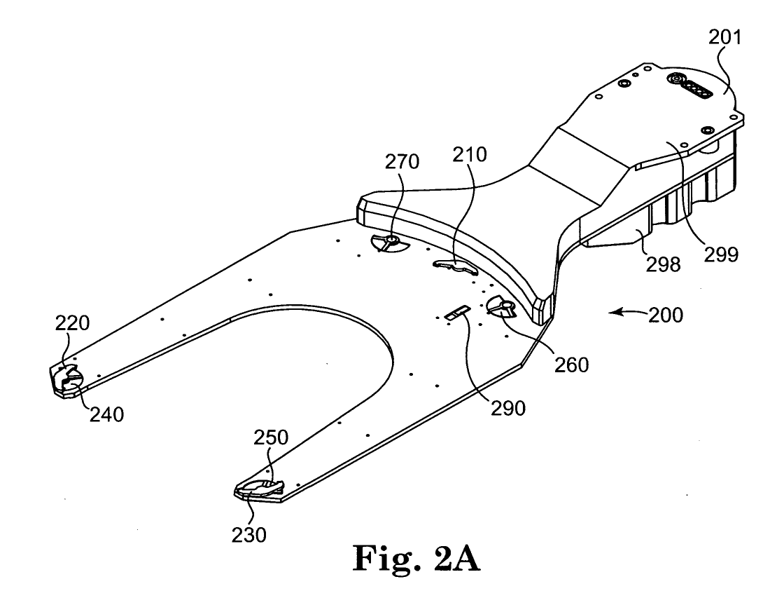

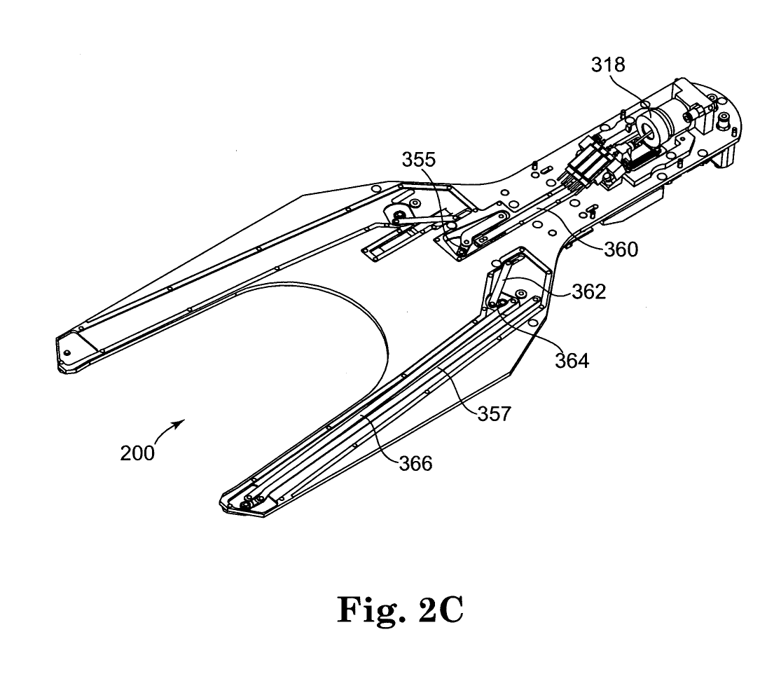

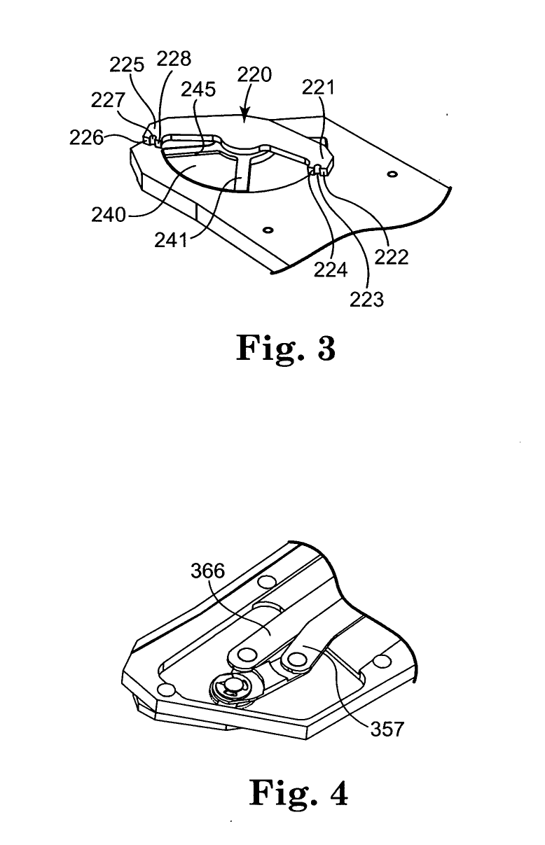

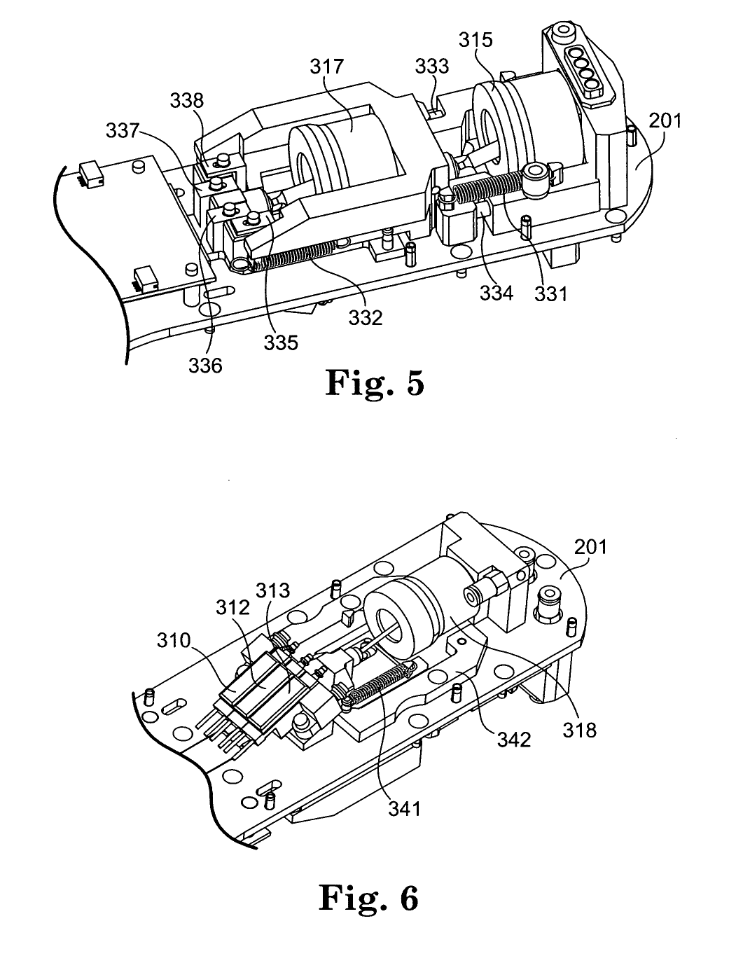

Another preferred embodiment of the present invention is shown as end effector 200 in FIGS. 2A-6 and is described below.

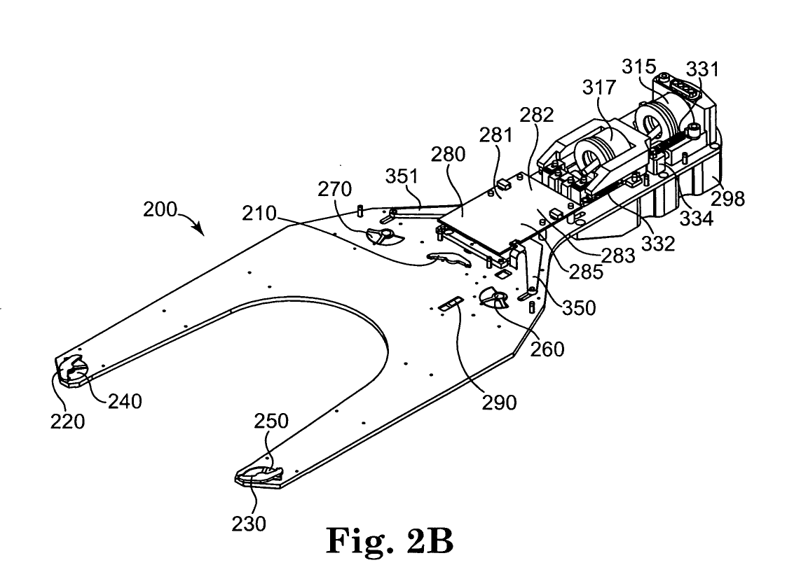

As shown, end effector 200 includes three sets of active grippers 210, 220, and 230 located around the perimeter of a wafer (not shown) for gripping. The gripper sets 210, 220, and 230, are spaced around the periphery of a wafer to help prevent motion of the wafer in all degrees of freedom when gripped. As shown, gripping set 210 is a proximal gripper set and gripping sets 220 and 230 are two opposing distal gripper sets. Each set 210, 220, and 230, includes one gripper contact pad dedicated for handling clean wafers and one dedicated for handling dirty wafers. As shown in FIG. 3, distal gripper set 220 includes gripper contact pad 221 dedicated for handling clean wafers and gripper contact pad 225 dedicated for handling dirty wafers. End effector 200 preferably allows handling 300mm notched wafers (not shown) without regard to orientation of the notch. Each gripper contact pad of each gripper set 210, 220, and 230, has a recess which results in two surfaces that can contact the wafer and thereby provides gripping even if the wafer notch is aligned with one of the grip surfaces. For example, as shown in FIG. 3, gripper contact pad 221 has a recess 223 which results in two surfaces 222 and 224 that can contact a clean wafer and gripper contact pad 225 has a recess 227 which results in two surfaces 226 and 228 that can contact a dirty wafer. The gripper strategy preferably touches the edges only but does not touch the top or bottom of a wafer so it complies with the 1 mm edge exclusion zones currently desired in the semiconductor industry. As shown in FIG. 3, the faces 222 and 224 of gripper pad 221 and faces 226 and 228 of gripper pad 225 that can contact a wafer are not orthogonal to the plane of a wafer. Preferably, there is a slight angle to ensure contact is only along the edge and the gripping force also has a force component that clamps the wafer against the appropriate surface of the landing pad sets 240, 250, 260, and 270.

As shown, near each gripper set 210, 220, and 230, are rotatable landing pad sets 240, 250, 260, and 270, which provide the surfaces used for transferring the wafer to/from other locations (i.e. chuck or FOUP). The landing pad sets 240, 250, 260, and 270 define a plane that provide a stable surface that a wafer (not shown) rests on during transfer of the wafer onto or off the end effector 200. As shown, four pad sets 240, 250, 260, and 270 are used for symmetry to help minimize wafer deflection. However, any suitable number of sets could be used (e.g., three sets). Like the gripper sets 210, 220, and 230, each landing pad set 240, 250, 260, and 270 also has a surface for contacting clean wafers and a different surface for contacting dirty wafers. For example, as shown in FIG. 3 distal pad set 240 has a surface 241 for contacting clean wafers and a different surface 245 for contacting dirty wafers. These surfaces of each landing pad set 240, 250, 260, and 270 are angled slightly off the plane of the wafer to help ensure contact is only along the edge of the wafer. The landing pad sets 240, 250, 260, and 270 are rotatable to select the desired contact surface depending on what type of wafer (clean or dirty) is being handled.

The end effector 200 utilizes angled contact surfaces on the landing pad sets 240, 250, 260, and 270, and gripper sets 210, 220, and 230, to minimize contact area with the wafer and reduce particle generation/transfer. The grip contact points (e.g., surfaces 222 and/or 224, or surfaces 226 and/or 228) and the landing pad surfaces (e.g., surfaces 241 or 245) make contact on the edges of a wafer and comply with a 1 mm edge exclusion zone.

As shown, the dual touch end effector 200 embodies active gripping sets 210, 220, and 230, driven by actuators 315 and 317, and separate active landing pad sets 240, 250, 260, and 270, driven by actuator 318. As shown, the grip motions of the gripper sets 210, 220, and 230, are controlled with the two (2) vacuum actuators 315 and 317 that are coupled together in series. As shown, vacuum actuators 315 and 317 are preferably used for actuating the gripping linkages 350, 351, 355, and 357. Preferably, linkages 350, 351, 355, and 357, are used to control/coordinate the motion of all the gripper sets 210, 220, and 230, simultaneously. As shown, vacuum actuator 318 is preferably used for actuating the landing pad linkages 360, 362, 364, and 366, thereby causing the landing pad sets 240, 250, 260, and 270, to rotate. Vacuum actuators are desirable because the companion robot (not shown) can provide a vacuum source and equally important because they are able to generate the relatively high forces and long strokes required to grip a wafer and accomplish this in a small packaging volume at a low cost. Gripping forces could be generated with solenoids or motors.

As shown, there are three positions (two overgrip and a neutral) for the gripper sets 210, 220, and 230, that are defined by mechanical stops 335, 336, 337, and 338, and encompass the entire travel range of the gripper sets 210, 220, and 230. “Overgrip” refers to the position each appropriate contact pad of the gripper sets 210, 220, and 230 travels when no wafer is present. When a wafer is present, the grippers are prevented from moving to the overgrip positions and the forces applied to the linkage trying to drive them to the stops exert the gripping force on the wafer. The three positions are: overgrip for a clean wafer (springs 331 and 332 force the mechanisms to this position); neutral which is the pickup/handoff position (achieved by actuating one of the gripper vacuum actuators 317); overgrip for a dirty wafer (achieved by actuating both of the gripper vacuum actuators 315 and 317).

The mechanical stops 335, 336, 337, and 338 limit the maximum open and closed positions for each actuator 315 and 317 to ensure repeatable positioning. The gripper mechanism travel ranges are designed to accommodate variations in the wafer diameter. The neutral position allows clearance between both clean and dirty grippers and the wafer to allow for positional errors in wafer transfer (e.g., wafer diameter variations, robot teach errors, wafer drift on chuck or in FOUP, system repeatability, manufacturing tolerances, etc.). As shown, the proximal gripper set 210 opposes the two distal gripper sets 220 and 230 and therefore applies the same force as the sum of the two distal gripper sets 220 and 230.

As shown, all the landing pad sets 240, 250, 260, and 270, are actuated by a single vacuum actuator 318 and their motion is preferably controlled/coordinated simultaneously with linkages 360, 362, 364, and 366. As shown, the landing pad sets 240, 250, 260, and 270, have two positions, one for supporting clean wafers and one for dirty wafers. The landing pad sets 240, 250, 260, and 270, can be spring loaded to position the clean surface under a wafer. Vacuum can be used for compatibility with a companion robot (not shown), but other actuation technologies (e.g., solenoid, stepper motor) could be used, particularly since actuation forces are relatively low.

As illustrated, the motion of the gripper sets 210, 220, and 230, and landing pad sets 240, 250, 260, and 270, are non-linear due to the conversion of the linear motion of the actuators 315, 317, and 318, to rotary motion through the linkages 350, 351, 355, 357, 360, 362, 364, and 366. For the landing pad sets 240, 250, 260, and 270, the position for a clean surface such as 241 or dirty surface such as 245 is preferably repeatable. For the gripper sets 210, 220, and 230, the gripper engagement position when it contacts the wafer preferably helps the wafer remain centered on the end effector 200 whether handling a dirty wafer or a clean wafer. The linkage geometries have been selected to closely match the dirty and clean grip positions relative to a centered wafer. This gripping approach minimizes wafer movement on a given surface for each of the landing pad sets 240, 250, 260, and 270, during gripping operations to reduce particle generation.

The gripper sets 210, 220, and 230 can be spring loaded, such that a loss of facilities vacuum or electricity would position the clean gripper contact pads (e.g., gripper contact pad 221) in the gripped position. As shown, the gripper sets 210, 220, and 230, are spring biased using springs 331 and 332, and guide rods 333 and 334, to help provide a failsafe means of capturing the wafer in the event of power/facilities loss. Similarly, but independently, the landing pad sets 240, 250, 260, and 270, are spring biased using spring 341 and travel limiter 342 so they move to a known position in the event of power/facilities loss. Preferably both the gripper sets 210, 220, and 230, and the landing pad sets 240, 250, 260, and 270, default to the clean wafer positions if facilities vacuum or electrical power is lost. The rationale for this is to minimize potential wafer rework that could be required if the dirty contact points (e.g., faces 226 and 228 of gripper contact pad 225, and surface 245 of distal pad set 240) were to touch a clean wafer. It is more desirable to clean the clean end effector grippers and landing pads in the event they contact a dirty wafer during a loss of facilities vacuum or electricity than to rework a wafer.

During wafer handoff or pickup the wafer rests on a clean or dirty surface of each of the landing pad sets 240, 250, 260, and 270, momentarily and the gripper sets 210, 220, and 230, are open. It is desirable that the robot (not shown) position the end effector 200 very accurately and repeatably at the handoff and pickup locations (i.e. chuck or FOUP) to minimize movement of the wafer when the gripper sets 210, 220, and 230, close thereby reducing particle generation.

An exemplary end effector 200 mechanism operating sequence for cleaning a dirty wafer is shown below.

| | | | | | | | Gripper |
|---|---|---|---|---|---|---|---|
| | | | | | | | Sets 210, |
| | Actuator 315 | | Actuator 317 | | Actuator 318 | | 220, and 230 |
| Process step | Vacuum | Position | Vacuum | Position | Vacuum | Land Position | Position |
| Process Start @ | off | Extended | off | Extended | off | Clean | Clean Grip |
| out position | | | | | | | |
| Dirty wafer | on | Retracted | off | Extended | on | Dirty | open |
| pick up | | | | | | | |
| Move to station | on | Retracted | on | Retracted | on | Dirty | Dirty Grip |
| Dirty wafer | off | Extended | on | Retracted | on | Dirty | open |
| drop off | | | | | | | |
| Clean wafer | off | Extended | on | Retracted | off | Clean | open |
| pick up | | | | | | | |
| Move to station | off | Extended | off | Extended | off | Clean | Clean Grip |
| Clean wafer | off | Extended | on | Retracted | off | Clean | open |
| drop off | | | | | | | |

The design of end effector 200 can actively monitor for presence of a wafer and wafer grip conditions.

Optionally, Hall Effect sensors 280 and 281 can be positioned in a manner (e.g., coupled to the substrate gripping members) to be utilized to measure the position of the gripper sets 210, 220, and 230. As shown, the two Hall Effect sensors 280 and 281(one on each side of the neutral position) provide positional information about the position of the proximal gripper set 210 and by inference, the distal gripper sets 220 and 230. Calibration of the gripper sets 210, 220, and 230, positions and selectable position tolerance ranges for neutral, gripped and over-gripped (no wafer) allow for robust operation.

Optionally, Hall Effect sensors 282 and 283 can be positioned in a manner (e.g., coupled to the landing pad sets) to be used for conveying the position of the landing pad sets 240, 250, 260, and 270. As shown, two Hall Effect sensors 282 and 283 are used to cover the longer travel range of this mechanism, but a single unit with greater range could be utilized. Calibration of the landing pad sets 240, 250, 260, and 270, positions and selectable position tolerance ranges for clean and dirty allow for robust operation.

The Hall Effect sensors 280, 281, 282, and 283, can provide an analog signal that is fed to microcontroller 285 to monitor the positions of the gripper sets 210, 220, and 230, and the landing pad sets 240, 250, 260, and 270.

To enhance reliability, a capacitive sensor 290 can be positioned in a manner (e.g., coupled to the end effector 200 body portion) to detect the presence of a wafer. The on-board circuit card with microcontroller 285 contains an electronic resistor network that allows consistent, repeatable, autocalibration of wafer presence.

Monitoring of both the grip position sensors 280 and 281 and wafer presence sensor 290 with the microcontroller 285 permits a robust design with error recovery capability. The microcontroller 285 can provide discrete I/O bits or use serial communication via, e.g., RS-232 to receive commands from or provide status to a wafer handling controller (not shown).

This control architecture also enables implementation of diagnostic capabilities to the end effector 200 with appropriate code updates. Some of the many possible examples for built in diagnostics include one or more of the following: 1) If the actuation time varies this could indicate facilities vacuum variations or wear/leakage in the actuators (actuators 315, 317, or 318); 2) If the actuation profile changes perky or intermittent) this could point to problems with binding in the mechanisms or broken spring (springs 331, 332, or 341); and 3) If the nominal wafer grip position varies over time this could be a sign of wear on the gripper contact surfaces (clean contact faces 222 and 224 or dirty contact faces 226 and 228) or in the actuating mechanisms.

Preferably, an on-board microcontroller 285 performs local monitoring and control of the end effector 200. Communication between the end effector microcontroller 285 and the rest of the system (not shown) is preferably via RS-232, but other methods could be used. The microcontroller 285 can perform one or more of the following functions: controlling the two solenoid vacuum control valves 310 and 312 that energize the two actuators 315 and 317 for the gripper sets 210, 220, and 230; controlling the solenoid vacuum control valve 313 that energizes the actuator 318 for the landing pad sets 240, 250, 260, and 270; calibration and monitoring the Hall Effect sensors 280 and 281 for gripper position; calibration and monitoring of the capacitive sensor 290 used for sensing presence of a wafer.

Linkages and components are preferably low profile to enable movement between wafers in a FOUP. Larger components (e.g., actuators 315, 317, and 318, circuit card with microcontroller 285, control valves 310, 312, and 313, and the like) are located near the end effector attachment area 201 to the robot (not shown). Moving components are preferably enclosed with housings or covers such as 298 and 299 and a purge vacuum is preferably applied within to contain and evacuate any particles generated during operation.

Structural components of end effector 200 are preferably fabricated from aluminum and polyetheretherketone (PEEK) is used for wafer contact surfaces. Other materials could be utilized (e.g., composite laminates to decrease deflections, stainless steel to decrease cost, ceramics for high temperature applications, combinations of these, and the like).

Overall geometry, deflections and grip capabilities of end effectors 100 and 200 are preferably compatible with high throughput movement of wafers when attached to a, e.g., six-axis robotic arm (not shown), or other wafer handling mechanism, when subjected to accelerations and velocities required for high throughput. The approach may also be applicable for other wafer sizes.

Potential uses for an end effector according to the present invention include semiconductor capital equipment companies or companies that sell wafer handling equipment to the semiconductor industry. Potential uses particularly for end effector 200 include applications where it is desirable to have dual gripping surfaces and/or dual contact areas. As shown, end effectors 100 and 200 can be used with 300 mm wafers (not shown) and have a geometry that is compatible with SEMI E1.9 FOUP exclusion specifications.

Other potential applications for an end effector according to the present invention include other robotic or handling applications where reduced contact area or peripheral gripping is desired (e.g., in medical or food processing where low contamination is desired).

What is claimed is:

1. An end effector comprising:
an end effector body portion having a proximal end and a distal end;
at least three substrate support members, wherein each substrate support member is coupled to the end effector body portion in a manner such that the substrate support members can support a substrate; and
at least three substrate gripping members, wherein each substrate gripping member is movably coupled to the end effector body portion in a manner such that the substrate gripping members can grip and release a wafer supported on the substrate support members.

2. The end effector of claim 1, further comprising:
at least one non-contact sensor incorporated into the end effector and positioned in a manner such that the sensor can detect whether a substrate is positioned on the substrate support members; and
at least one non-contact sensor incorporated into the end effector and positioned in a manner so as to detect the position of the grippers.

3. An end effector comprising:
an end effector body portion having a proximal end and a distal end;
at least four substrate support members, wherein each substrate support member is unmovably coupled to the end effector body portion in a manner such that the substrate support members can support a substrate; and
at least three substrate gripping members, wherein each substrate gripping member is movably coupled to the end effector body portion in a manner such that the substrate gripping members can move linearly within the main plane of the end effector and along an axis so as to grip and release a wafer supported on the substrate support members.

4. The end effector of claim 3, further comprising:
at least one non-contact sensor incorporated into the end effector and positioned in a manner such that the sensor can detect whether a substrate is positioned on the substrate support members; and
at least one non-contact sensor incorporated into the end effector and positioned in a manner so as to detect the position of the grippers.

5. An end effector comprising:
an end effector body portion having a proximal end and a distal end;
at least four substrate support members, wherein each substrate support member has at least a first and a second wafer contact area and wherein each substrate support member is movably coupled to the end effector body portion in a manner such that each substrate support member can rotate about an axis and such that either all of the first wafer contact areas or all of the second wafer contact areas of the substrate support members are positioned so as to support a substrate; and
at least three substrate gripping members, wherein each substrate gripping member has at least a first and a second wafer contact area and wherein each substrate gripping member is movably coupled to the end effector body portion in a manner such that each substrate gripping member can rotate about an axis and such that either all of the first wafer contact areas or all of the second wafer contact areas of the gripping members are positioned so as to grip and release a wafer supported on the substrate support members.

6. The end effector of claim 5, further comprising:
at least one non-contact sensor incorporated into the end effector and positioned in a manner such that the sensor can detect whether a substrate is positioned on the substrate support members;
at least one non-contact sensor incorporated into the end effector and positioned in a manner so as to detect the position of the substrate support members; and
at least one non-contact sensor incorporated into the end effector and positioned in a manner so as to detect the position of the grippers.
